(19) United States
(12) Patent Application Publication
(10) Pub. No.: US 2026/0287364 A1
(43) Pub. Date: Sep. 24, 2026

(54) SYSTEMS AND METHODS FOR NAVIGATING AND MONITORING INFRASTRUCTURE USING ACOUSTIC SIGNALS

(71) Applicant: Verizon Patent and Licensing Inc., Basking Ridge, NJ (US)

(72) Inventors: Sumanth S. MALLYA, Dallas, TX (US); Haris KALLIPARAMBIL MOHAMADALI, Thrissur (IN); Sanoop Raj PUSHPARAJAN SUVARNA, Kozhikode (IN)

(73) Assignee: Verizon Patent and Licensing Inc., Basking Ridge, NJ (US)

(21) Appl. No.: 19/084,980

(22) Filed: Mar. 20, 2025

(51) Int. Cl. G01C 21/20; G01C 21/00; G06N 3/0442; G06N 3/0464

(52) U.S. Cl. CPC G01C 21/206; G01C 21/3841; G06N 3/0442; G06N 3/0464

(57) ABSTRACT

A device may receive terrestrial data and location data at multiple locations within an infrastructure and during different time periods, and may overlay the terrestrial data and the location data on a floor plan of the infrastructure to generate an terrestrial map for the infrastructure. The device may store the terrestrial map in a data structure associated with the device, and may train a machine learning model, with the terrestrial data, the location data, and the terrestrial map, to generate a trained machine learning model. The device may perform one or more actions using the trained machine learning model.

### BACKGROUND

Efficient positioning, navigation, and monitoring of an infrastructure have become increasingly important. For example, a user may need to identify a current user location within an infrastructure, and may need to navigate through the infrastructure. Furthermore, the infrastructure may include expensive equipment and may need to be monitored to prevent theft of such equipment and proper functioning of such equipment.

### BRIEF DESCRIPTION OF THE DRAWINGS

FIGS. 1A-1G are diagrams of an example associated with navigating and monitoring infrastructure using terrestrial signals.

FIG. 2 is a diagram illustrating an example of training and using a machine learning model.

FIG. 3 is a diagram of an example environment in which systems and/or methods described herein may be implemented.

FIG. 4 is a diagram of example components of one or more devices of FIG. 3.

FIG. 5 is a flowchart of an example process for navigating and monitoring infrastructure using terrestrial signals.

### DETAILED DESCRIPTION OF EXAMPLE EMBODIMENTS

The following detailed description of example implementations refers to the accompanying drawings. The same reference numbers in different drawings may identify the same or similar elements.

Infrastructure, such as data centers, server rooms, and warehouses, may be equipped with mechanical and electrical equipment that produce acoustic noise that varies with a level of utilization and characteristics of the equipment. Existing methods of indoor navigation and monitoring often involve the installation of new devices or reliance on radio frequency (RF) signals that may require significant infrastructural adjustments. Current systems may employ beacons, barcodes, or additional sensors to facilitate navigation and monitoring, which can be costly and time-consuming to implement. Thus, current techniques for navigating and monitoring infrastructures consume computing resources (e.g., processing resources, memory resources, communication resources, and/or the like), networking resources, and/or other resources associated with installing new devices and/or systems for navigating and monitoring an infrastructure, maintaining the new devices and/or systems, poorly monitoring an infrastructure, failing to identify bad actors in an infrastructure based on poorly monitoring the infrastructure, failing to identify equipment issues in an infrastructure based on poorly monitoring the infrastructure, and/or the like.

Some implementations described herein provide a monitoring system that enables navigating and monitoring infrastructure using terrestrial signals (e.g., acoustic signals, magnetic signals, infrared signals, magnetic signals, wireless signals, and/or the like). For example, the monitoring system may receive terrestrial data and location data at multiple locations within an infrastructure and during different time periods, and may overlay the terrestrial data and the location data on a floor plan of the infrastructure to generate an terrestrial map for the infrastructure. The monitoring system may store the terrestrial map in a data structure associated with the monitoring system, and may train one or more machine learning models, with the terrestrial data, the location data, and the terrestrial map, to generate one or more trained machine learning models. The monitoring system may perform one or more actions using the one or more trained machine learning models.

In this way, the monitoring system enables navigating and monitoring infrastructure using terrestrial signals. For example, the monitoring system may receive terrestrial data and location data associated with an infrastructure, and may overlay this data onto a floor plan of the infrastructure to create an terrestrial map. The monitoring system may train machine learning models, with the terrestrial data, location data, and the terrestrial map, to generate trained machine learning models, and may then perform actions based on the trained machine learning models. In some implementations, the monitoring system may utilize the trained machine learning models to monitor the infrastructure in real-time to identify deviations from expected terrestrial patterns and to generate alerts when deviations are detected. The monitoring system may also utilize the trained machine learning models to predict locations of user devices within the infrastructure based on terrestrial intensities captured by the user devices. Thus, the monitoring system may conserve computing resources, networking resources, and/or other resources that would have otherwise been consumed by installing new devices and/or systems for navigating and monitoring an infrastructure, maintaining the new devices and/or systems, poorly monitoring an infrastructure, failing to identify bad actors in an infrastructure based on poorly monitoring the infrastructure, failing to identify equipment issues in an infrastructure based on poorly monitoring the infrastructure, and/or the like.

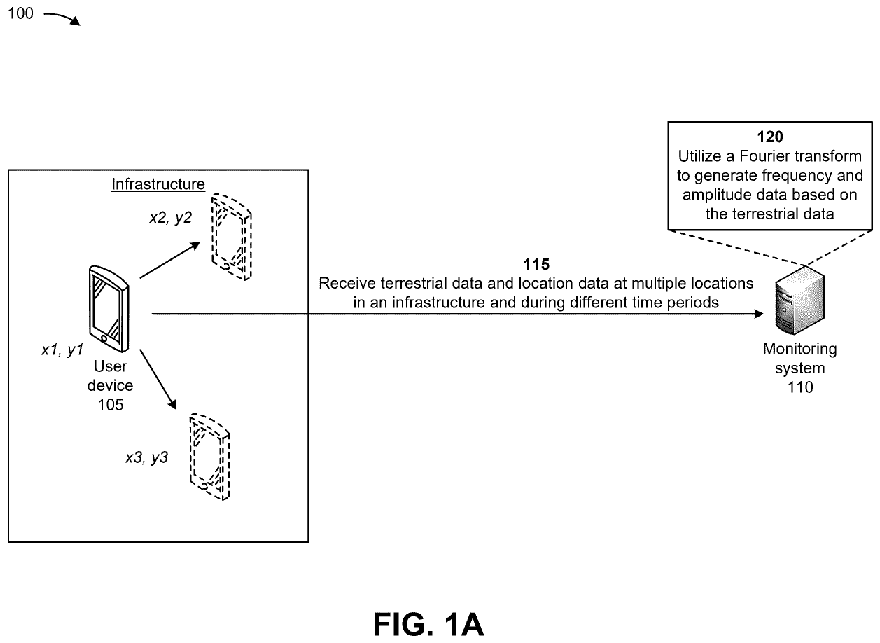

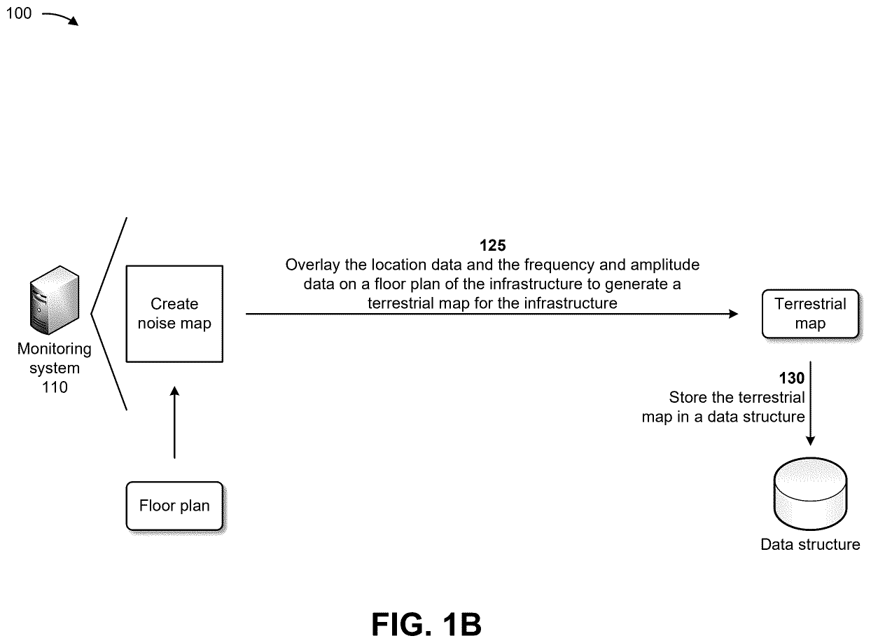

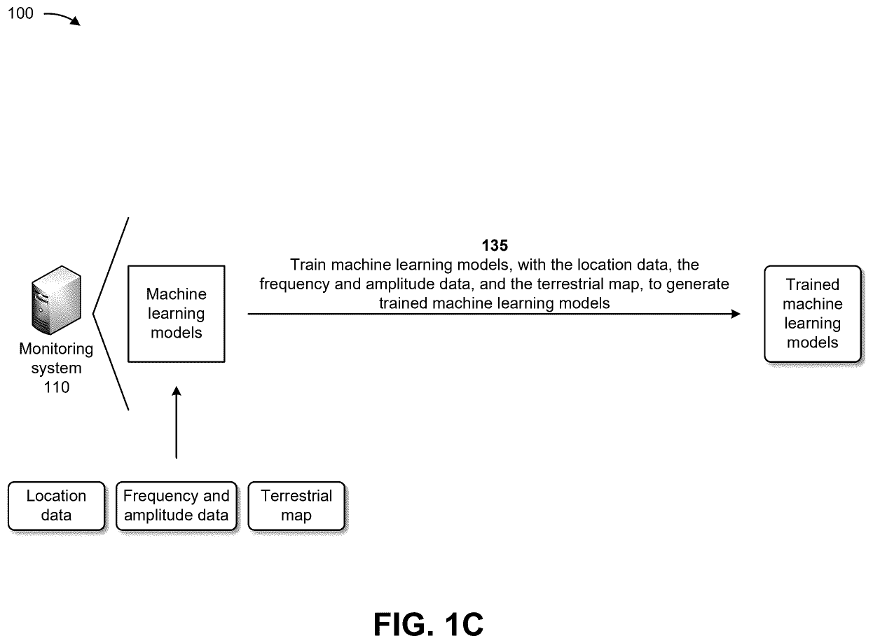

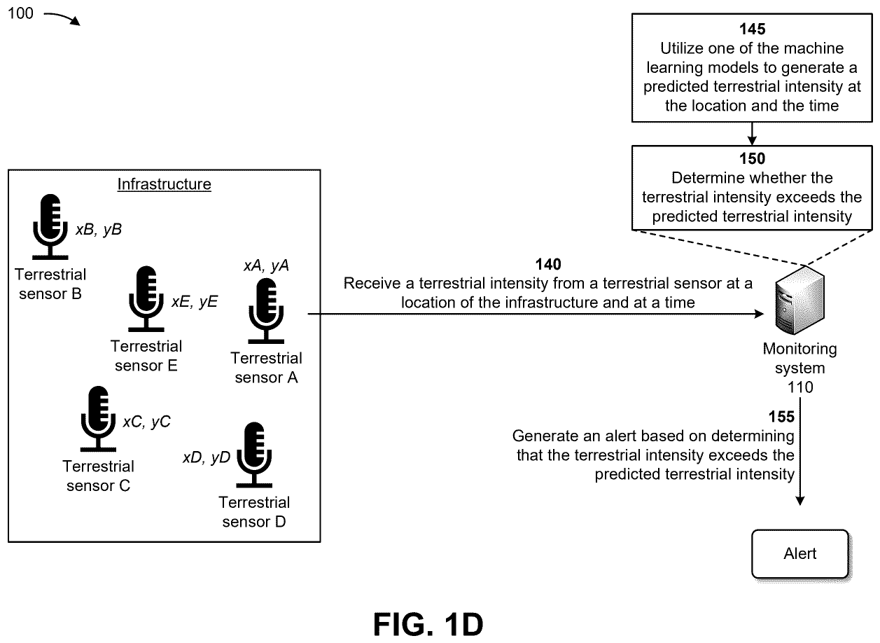

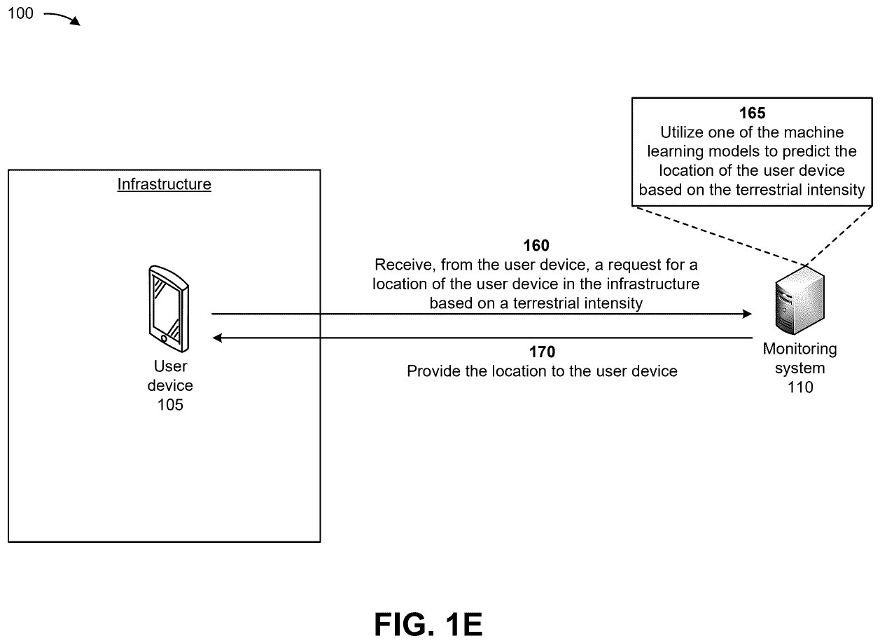

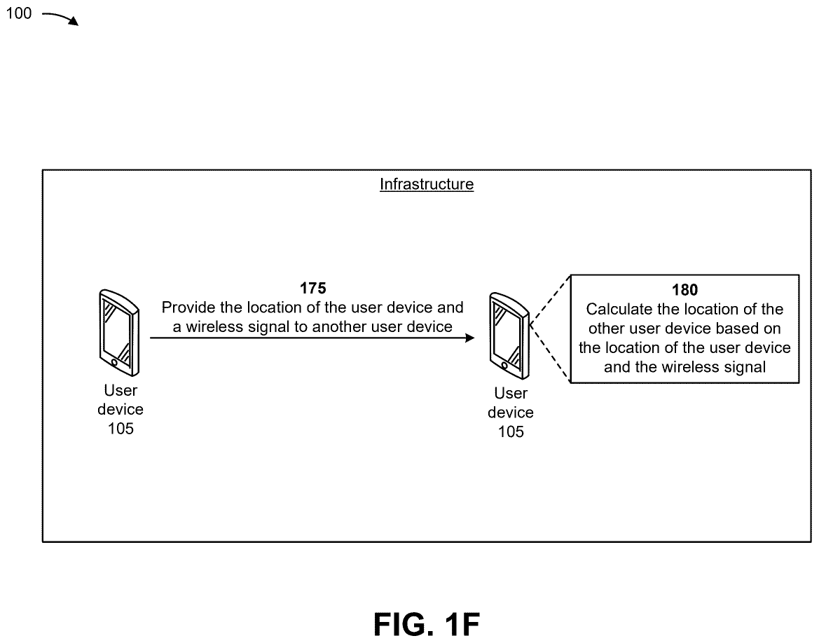

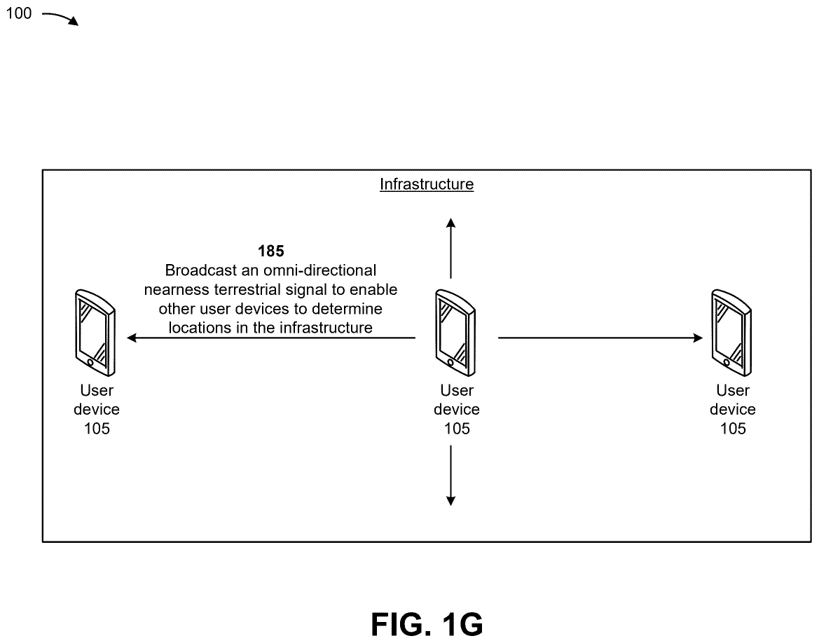

FIGS. 1A-1G are diagrams of an example 100 associated with navigating and monitoring infrastructure using terrestrial signals. As shown in FIGS. 1A-1G, the example 100 includes a user device 105 associated with a monitoring system 110. The user device 105 may be located in an infrastructure (e.g., a data center, a server room, a warehouse, a factory, an outdoor area, and/or the like). The monitoring system 110 may include a system that enables navigating and monitoring infrastructure using terrestrial signals. The terrestrial signals may include acoustic signals, magnetic signals, infrared signals, magnetic signals, wireless signals, and/or the like. Further details of the user device 105 and the monitoring system 110 are provided elsewhere herein. Although implementations described herein depict a single user device 105, in some implementations, the monitoring system 110 may be associated with multiple user devices 105. In some implementations, the monitoring system 110 may be deployed remotely from the infrastructure and in a cloud computing environment. Alternatively, or additionally, the monitoring system 110 may be deployed locally to the infrastructure in one or more mobile edge computing (MEC) devices.

As shown in FIG. 1A, and by reference number 115, the monitoring system 110 may receive terrestrial data and location data at multiple locations in an infrastructure and during different time periods. For example, the user device 105 (e.g., a noise meter, a smartphone, a spectrum analyzer, a radio frequency meter, and/or the like), coupled with a location tracker, may move throughout the infrastructure at different times (e.g., during peak load or usage of the infrastructure, during minimal load or usage of the infrastructure, during night time usage of the infrastructure, and/or the like) and may capture terrestrial data and location data (e.g., latitude and longitude coordinates). The user device 105 may provide the terrestrial data and the location data to the monitoring system 110. In some implementations, the monitoring system 110 may periodically receive the terrestrial data and the location data from the user device 105, may continuously receive the terrestrial data and the location data from the user device 105, may receive the terrestrial data and the location data from the user device 105 based on requesting the data from the user device 105, and/or the like.

As further shown by FIG. 1A, and by reference number 120, the monitoring system 110 may utilize a Fourier transform to generate frequency and amplitude data based on the terrestrial data. For example, the monitoring system 110 may apply the Fourier transform to the terrestrial data to convert terrestrial signals of the terrestrial data into corresponding frequencies and amplitudes (e.g., the frequency and amplitude data). In some implementations, the Fourier transform may include a fast Fourier transform (FFT), a discrete Fourier transform (DFT), a short-time Fourier transform (STFT), and/or the like. The FFT may compute a DFT and an inverse DFT, which makes the FFT suitable for real-time monitoring applications. The DFT may provide a discrete set of frequency and amplitude data points, which may be useful for detailed spectral analysis. The STFT may enable frequency analysis over short time windows, making the STFT useful for analyzing non-stationary signals that vary over time.

Additionally, or alternatively, instead of using a Fourier transform, the monitoring system 110 may utilize a wavelet transform to generate the frequency and amplitude data based on the terrestrial data. The wavelet transform may provide a time-frequency representation of a signal, which may provide better resolution for certain types of terrestrial signals. Additionally, or alternatively, the monitoring system 110 may utilize a Hilbert transform to generate the frequency and amplitude data based on the terrestrial data. The Hilbert transform may obtain an analytic signal, which provides instantaneous frequency and amplitude data. Additionally, or alternatively, the monitoring system 110 may perform spectral analysis on the terrestrial data to generate the frequency and amplitude data. Spectral analysis techniques may be employed to examine a power spectrum and identify dominant frequencies in the terrestrial data.

Additionally, or alternatively, the monitoring system 110 may implement a Cepstral analysis to generate the frequency and amplitude data based on the terrestrial data. A Cepstral analysis may enable analyzing echoes and reverberations in an terrestrial signal. Additionally, or alternatively, the monitoring system 110 may employ harmonic analysis to generate the frequency and amplitude data based on the terrestrial data. Harmonic analysis may identify periodic components in terrestrial signals. Additionally, or alternatively, the monitoring system 110 may utilize an autoregressive (AR) model to generate the frequency and amplitude data based on the terrestrial data. Additionally, or alternatively, the monitoring system 110 may use a combination of the Fourier transform and other signal processing techniques to generate the frequency and amplitude data based on the terrestrial data. This hybrid approach may utilize the strengths of multiple techniques to provide a comprehensive analysis of the terrestrial data.

As shown in FIG. 1B, and by reference number 125, the monitoring system 110 may overlay the location data and the frequency and amplitude data on a floor plan of the infrastructure to generate an terrestrial map for the infrastructure. For example, the monitoring system 110 may utilize the location data (e.g., latitude and longitude coordinates) and the frequency and amplitude data (e.g., derived from terrestrial signals using Fourier transforms) to create a visual representation (e.g., an terrestrial map) of the terrestrial environment within the infrastructure. The terrestrial map may provide detailed spatial information regarding terrestrial signatures at various locations within the infrastructure. In some implementations, the floor plan for the infrastructure may include a scaled diagram that represents the layout of a building or facility from a top-down perspective. The floor plan may include an arrangement of rooms, hallways, and other physical spaces, as well as placement of doors, windows, and significant equipment or furniture. The floor plan may also indicate utility systems such as electrical, plumbing, and heating, ventilation, and air conditioning (HVAC), and may be utilized for navigation, planning, and monitoring purposes within the infrastructure.

As further shown in FIG. 1B, and by reference number 130, the monitoring system 110 may store the terrestrial map in a data structure. For example, the monitoring system 110 may store the terrestrial map in a data structure (e.g., a database, a table, a list, and/or the like) associated with the monitoring system 110. The storage of the terrestrial map may enable efficient retrieval and use of the terrestrial map for various applications, such as navigation, infrastructure monitoring, and asset tracking within the infrastructure. In some implementations, the data structure may include a data repository, a cloud storage system, a data storage module, a distributed storage network, a server-based storage system, a relational database, and/or the like. Alternatively, or additionally, the monitoring system 110 may provide the terrestrial map to a mobile edge computing (MEC) device geographically located at the infrastructure, and the MEC device may store the terrestrial map. The MEC device may bring computational and storage resources closer to the location of the infrastructure. The MEC device may enable real-time data processing and analysis by reducing latency and improving the efficiency of data handling. The MEC device may provide localized processing power for generating and utilizing terrestrial maps within the infrastructure, enhancing responsiveness and reducing the need for extensive data transmission to distant infrastructures.

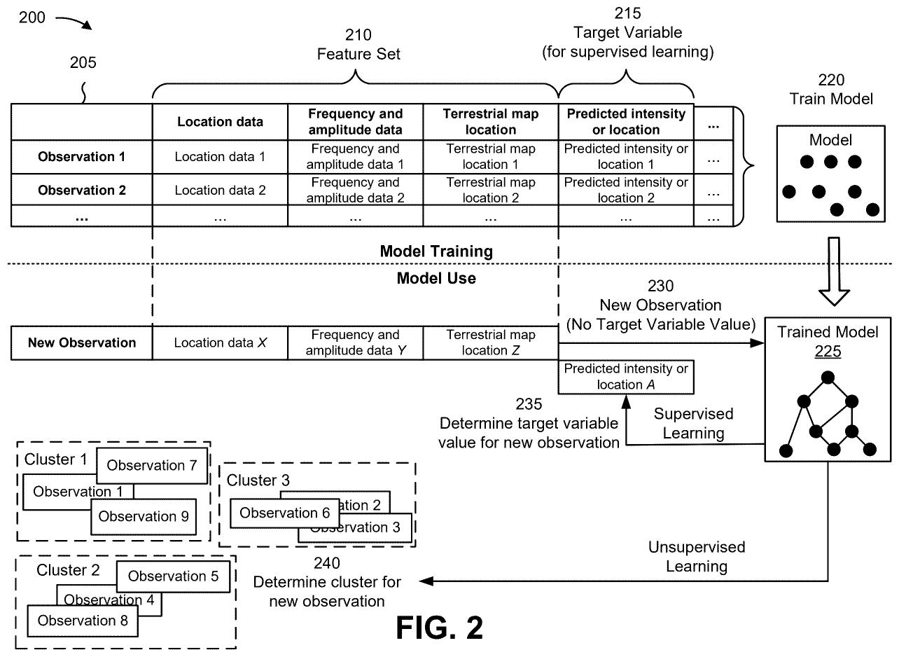

As shown in FIG. 1C, and by reference number 135, the monitoring system 110 may train machine learning models with the location data, the frequency and amplitude data, and the terrestrial map, to generate trained machine learning models. For example, the monitoring system 110 may utilize historical location data, the location data, the frequency and amplitude data, and the terrestrial map to train machine learning models. Further details of training a machine learning model are provided below in connection with FIG. 2. In some implementations, the monitoring system 110 may train a long short-term memory (LSTM) model for predicting future terrestrial intensities based on locations and times, and may train a convolutional neural network (CNN) model for identifying specific locations within the infrastructure based on terrestrial and magnetic signals. In some implementations, the LSTM model may include three layers with 256 hidden units each and may be trained using an Adam optimizer with a particular learning rate (e.g., about 0.001). The CNN model may include five convolutional layers with ReLU activation functions and max-pooling layers, followed by two fully connected layers.

The monitoring system 110 may utilize the trained machine learning models to perform various actions, such as real-time monitoring, anomaly detection, and location prediction within the infrastructure. In some implementations, the monitoring system 110 may utilize the trained machine learning models to monitor the infrastructure in real-time for detecting anomalies in terrestrial patterns and generating alerts based on the detected anomalies. For example, the monitoring system 110 may analyze terrestrial data to identify deviations from terrestrial data predicted by a trained machine learning model, which may indicate potential issues or security breaches.

Additionally, or alternatively, the monitoring system 110 may utilize a combination of the LSTM model and the CNN model to improve the accuracy of location predictions and anomaly detection within the infrastructure. This combination leverages the strengths of both models, enhancing an ability of the monitoring system 110 to accurately interpret complex terrestrial environments. Additionally, or alternatively, the monitoring system 110 may utilize the trained machine learning models to predict future terrestrial patterns and identify deviations from expected patterns, facilitating preventive maintenance and timely interventions. This proactive approach may ensure that potential problems are addressed before escalating, thereby maintaining the integrity and functionality of the infrastructure.

Additionally, or alternatively, the monitoring system 110 may utilize the trained machine learning models to assist user devices 105 in navigating the infrastructure by providing location information based on real-time terrestrial signal data. This may be particularly useful in environments where global positioning system (GPS) signals may be weak or unavailable. Additionally, or alternatively, the monitoring system 110 may provide the trained machine learning models to a MEC device located at the infrastructure to enable low-latency processing and real-time decision-making. This may ensure that critical data processing occurs close to a source, reducing a time required for analysis and response. Additionally, or alternatively, the monitoring system 110 may generate and update the terrestrial map periodically using newly recorded terrestrial data, and may retrain the machine learning models to ensure the accuracy and reliability of the trained machine learning models. Regular updates to the terrestrial map maintain an effectiveness of the monitoring system 110 as infrastructure conditions change over time.

Additionally, or alternatively, the monitoring system 110 may utilize the trained machine learning models to predict potential terrestrial disturbances and optimize placement and operation of infrastructure equipment. This predictive capability may enable the monitoring system 110 to manage the infrastructure more efficiently by anticipating and mitigating potential issues. Additionally, or alternatively, the monitoring system 110 may further train the trained machine learning models with additional data (e.g., sensor data, such as temperature and humidity) to provide a comprehensive monitoring solution for the infrastructure. By combining data from multiple sources, the monitoring system 110 may offer a more holistic view of the infrastructure's condition and performance. Additionally, or alternatively, the monitoring system 110 may utilize the trained machine learning models to enhance the security of the infrastructure by detecting unauthorized activities based on unusual terrestrial signatures. This added layer of security may protect the infrastructure from potential threats and unauthorized access.

As shown in FIG. 1D, and by reference number 140, the monitoring system 110 may receive an terrestrial intensity from an terrestrial sensor at a location of the infrastructure and at a time. For example, one or more terrestrial sensors (e.g., terrestrial sensor A, terrestrial sensor B, terrestrial sensor C, terrestrial sensor D, terrestrial sensor E, and/or the like) may be deployed at different locations within the infrastructure. Each terrestrial sensor is positioned at specific coordinates (e.g., xA and yA, xB and yB, xC and yC, xD and yD, xE and yE, and/or the like) to capture terrestrial signals (e.g., intensities) at corresponding locations. The terrestrial sensors may be strategically placed to monitor specific areas of the infrastructure, and may provide comprehensive terrestrial coverage of the infrastructure. In some implementations, the monitoring system 110 may receive an terrestrial intensity from one or more of the terrestrial sensors. For example, the monitoring system 110 may receive an terrestrial intensity captured by an terrestrial sensor (e.g., terrestrial sensor A) provided at a location of the infrastructure and at a particular time. In some implementations, the monitoring system 110 may receive the terrestrial intensity from a user device 105 located at the location of the infrastructure at the particular time. For example, the user device 105 may be carried by a user to the location within the infrastructure, and may collect the terrestrial intensity at the time. The user device 105 may provide the terrestrial intensity to the monitoring system 110 for analysis.

As further shown in FIG. 1D, and by reference number 145, the monitoring system 110 may utilize one of the machine learning models to generate a predicted terrestrial intensity at the location and the time. For example, the monitoring system 110 may process the terrestrial intensity, with one of the trained machine learning models (e.g., the LSTM model), to generate a predicted terrestrial intensity at the specific location and time. The LSTM model may leverage temporal data to provide accurate predictions over time. In some implementations, the monitoring system 110 may utilize the Fourier transform to convert the terrestrial intensity into frequency and amplitude data, and may utilize the frequency and amplitude data to generate predicted terrestrial intensity. This transformation may aid in analyzing the terrestrial signals more effectively by breaking the terrestrial signals down into frequency components.

As further shown in FIG. 1D, and by reference number 150, the monitoring system 110 may determine whether the terrestrial intensity sufficiently deviates from the predicted terrestrial intensity (e.g., greater than 10%, 20%, 30%, and/or the like). For example, the monitoring system 110 may compare the received terrestrial intensity to the predicted terrestrial intensity to identify any deviations that exceed or fails to meet a predefined threshold. A deviation between the terrestrial intensity and the predicted terrestrial intensity, that sufficiently deviates from (e.g., exceeds or falls below) the predefined threshold, may indicate potential anomalies or issues within the infrastructure. In some implementations, the deviations may be critical indicators of problems in the infrastructure, such as equipment malfunction or unauthorized activities within the infrastructure.

As further shown in FIG. 1D, and by reference number 155, the monitoring system 110 may generate an alert based on determining that the terrestrial intensity sufficiently deviates from the predicted terrestrial intensity. For example, if the terrestrial sufficiently deviates from the predicted value (e.g., and the predefined threshold), the monitoring system 110 may generate and send an alert to notify relevant personnel or systems of the detected anomaly. The alert may include details such as the location, time, and the magnitude of the deviation, enabling timely intervention and resolution. In some implementations, generating the alert may include the monitoring system 110 sending, to a remote system, a notification indicating that the terrestrial intensity sufficiently deviates from the predicted terrestrial intensity. For example, the notification may indicate that an intruder is in the infrastructure, and the emergency system may dispatch law enforcement personnel to the infrastructure based on the notification.

As shown in FIG. 1E, and by reference number 160, the monitoring system 110 may receive, from the user device 105, a request for a location of the user device 105 in the infrastructure based on an terrestrial intensity. For example, the user device 105 may capture an terrestrial intensity at a particular location within the infrastructure, and may generate a request for the location of the user device 105 based on the captured terrestrial intensity. The user device 105 may provide the request and the terrestrial intensity to the monitoring system 110, and the monitoring system 110 may receive the request and the terrestrial intensity. In some implementations, the terrestrial intensity may include terrestrial data, magnetic data, infrared data, magnetic data, wireless data, and/or the like captured at the location within the infrastructure.

As further shown in FIG. 1E, and by reference number 165, the monitoring system 110 may utilize one of the machine learning models to predict the location of the user device 105 based on the terrestrial intensity. For example, the monitoring system 110 may process the terrestrial intensity, with one of trained machine learning models (e.g., the CNN model), to determine the location of the user device 105 within the infrastructure. The CNN model may analyze patterns within the terrestrial intensity to accurately predict the location of the user device 105 within the infrastructure. Additionally, or alternatively, the monitoring system 110 may utilize another machine learning model that has been trained using a combination of terrestrial data to predict the location. By utilizing multiple data sources to train the other machine learning model, the monitoring system 110 may enhance a robustness and an accuracy of location predictions. In such implementations, the monitoring system 110 may process the terrestrial intensity, with the other machine learning model, to determine the location of the user device 105 within the infrastructure.

As further shown in FIG. 1E, and by reference number 170, the monitoring system 110 may provide the location to the user device 105. For example, once the monitoring system 110 has predicted the location of the user device 105, the monitoring system 110 may provide the predicted location to the user device 105. The user device 105 may may utilize the location information for various purposes, such as navigation, asset tracking, or infrastructure monitoring. In some implementations, the monitoring system 110 may update the data structure with the predicted location. For example, the monitoring system 110 may utilize the predicted location stored in the data structure for historical tracking and analysis of movements of the user device 105 within the infrastructure. Additionally, or alternatively, the monitoring system 110 may provide the location to the user device 105 via a push notification. The push notification may enable the user device 105 to receive immediate updates on location. Additionally, or alternatively, the monitoring system 110 may also send an alert to an emergency system if any anomalies are detected. For example, if the predicted location deviates significantly from expected patterns, an alert may be generated to notify the emergency system of potential issues. Additionally, or alternatively, the monitoring system 110 may enable the user device 105 to share the location with other user devices 105 in a vicinity of the user device 105. This may facilitate coordination and communication between multiple user devices 105 within the infrastructure.

As shown in FIG. 1F, and by reference number 175, the user device 105 may provide the location of the user device 105 and a wireless signal to another user device 105. For example, after determining or receiving the location of the user device 105 within the infrastructure, the user device 105 may provide the location, along with a wireless signal (e.g., Bluetooth, Wi-Fi, infrared, and/or the like), to another user device 105 within a vicinity of the user device 105. The location and the wireless signal may enable the other user device 105 to determine a location of the other user device 105. This may provide seamless communication between user devices 105, and may enhance indoor positioning accuracy. In some implementations, the user device 105 may not receive the location from the monitoring system 110, but may determine the location based on the GPS component of the user device 105. The user device 105 may provide the GPS-determined location and the wireless signal to the other user device 105 within the vicinity of the user device 105.

As further shown in FIG. 1F, and by reference number 180, the other user device 105 may calculate the location of the other user device 105 based on the location of the user device 105 and the wireless signal. For example, the other user device 105 may receive the location and the wireless signal from the first user device 105, and may analyze a strength, a timing (e.g., a time of arrival), and characteristics of the wireless signal. By analyzing the strength, the timing, and the characteristics of the wireless signal, the other user device 105 can calculate a location of the other user device 105 relative to the user device 105 and within the infrastructure. This method of location determination may be particularly useful for dynamic and real-time positioning within the infrastructure, enabling accurate indoor navigation without the need for additional infrastructure.

As shown in FIG. 1G, and by reference number 185, the user device 105 may broadcast an omni-directional nearness terrestrial signal to enable other user devices 105 to determine locations in the infrastructure. For example, the user device 105 may emit the nearness terrestrial signal in all directions, allowing nearby user devices 105 to receive the signal and utilize signal to triangulate and determine locations of the user devices 105 within the infrastructure. This method of location determination may provide a reliable means for multiple user devices 105 to self-localize without relying on additional devices or external signals. In some implementations, the omni-directional nearness terrestrial signal may be enhanced with additional data, such as timing information or signal strength, to improve the accuracy of the location determination. For example, incorporating timing information in the omni-directional nearness terrestrial signal allows the user devices 105 to calculate distances more precisely, thereby refining location estimates.

In this way, the monitoring system 110 enables navigating and monitoring infrastructure using terrestrial signals. For example, the monitoring system 110 may receive terrestrial data and location data associated with an infrastructure, and may overlay this data onto a floor plan of the infrastructure to create an terrestrial map. The monitoring system 110 may train machine learning models, with the terrestrial data, location data, and the terrestrial map, to generate trained machine learning models, and may and perform actions based on the trained machine learning models. In some implementations, the monitoring system 110 may utilize the trained machine learning models to monitor the infrastructure in real-time to identify deviations from expected terrestrial patterns and to generates alerts when deviations are detected. The monitoring system 110 may also utilize the trained machine learning models to predict locations of user devices 105 within the infrastructure based on terrestrial intensities captured by the user devices 105. Thus, the monitoring system 110 may conserve computing resources, networking resources, and/or other resources that would have otherwise been consumed by installing new devices and/or systems for navigating and monitoring an infrastructure, maintaining the new devices and/or systems, poorly monitoring an infrastructure, failing to identify bad actors in an infrastructure based on poorly monitoring the infrastructure, failing to identify equipment issues in an infrastructure based on poorly monitoring the infrastructure, and/or the like.

As indicated above, FIGS. 1A-1G are provided as an example. Other examples may differ from what is described with regard to FIGS. 1A-1G. The number and arrangement of devices shown in FIGS. 1A-1G are provided as an example. In practice, there may be additional devices, fewer devices, different devices, or differently arranged devices than those shown in FIGS. 1A-1G. Furthermore, two or more devices shown in FIGS. 1A-1G may be implemented within a single device, or a single device shown in FIGS. 1A-1G may be implemented as multiple, distributed devices. Additionally, or alternatively, a set of devices (e.g., one or more devices) shown in FIGS. 1A-1G may perform one or more functions described as being performed by another set of devices shown in FIGS. 1A-1G.

FIG. 2 is a diagram illustrating an example 200 of training and using a machine learning model. The machine learning model training and usage described herein may be performed using a machine learning system. The machine learning system may include or may be included in a computing device, a server, a cloud computing environment, and/or the like, such as the monitoring system 110 described in more detail elsewhere herein.

As shown by reference number 205, a machine learning model may be trained using a set of observations. The set of observations may be obtained from historical data, such as data gathered during one or more processes described herein. In some implementations, the machine learning system may receive the set of observations (e.g., as input) from the monitoring system 110, as described elsewhere herein.

As shown by reference number 210, the set of observations includes a feature set. The feature set may include a set of variables, and a variable may be referred to as a feature. A specific observation may include a set of variable values (or feature values) corresponding to the set of variables. In some implementations, the machine learning system may determine variables for a set of observations and/or variable values for a specific observation based on input received from the monitoring system 110. For example, the machine learning system may identify a feature set (e.g., one or more features and/or feature values) by extracting the feature set from structured data, by performing natural language processing to extract the feature set from unstructured data, by receiving input from an operator, and/or the like.

As an example, a feature set for a set of observations may include a first feature of location data, frequency and amplitude data, a third feature of terrestrial map location, and so on. As shown, for a first observation, the first feature may have a value of location data 1, the second feature may have a value of frequency and amplitude data 1, the third feature may have a value of terrestrial map location 1, and so on. These features and feature values are provided as examples and may differ in other examples.

As shown by reference number 215, the set of observations may be associated with a target variable. The target variable may represent a variable having a numeric value, may represent a variable having a numeric value that falls within a range of values or has some discrete possible values, may represent a variable that is selectable from one of multiple options (e.g., one of multiple classes, classifications, labels, and/or the like), may represent a variable having a Boolean value, and/or the like. A target variable may be associated with a target variable value, and a target variable value may be specific to an observation. In example 200, the target variable may be entitled “predicted intensity or location” and may include a value of predicted intensity or location 1 for the first observation.

The target variable may represent a value that a machine learning model is being trained to predict, and the feature set may represent the variables that are input to a trained machine learning model to predict a value for the target variable. The set of observations may include target variable values so that the machine learning model can be trained to recognize patterns in the feature set that lead to a target variable value. A machine learning model that is trained to predict a target variable value may be referred to as a supervised learning model.

In some implementations, the machine learning model may be trained on a set of observations that do not include a target variable. This may be referred to as an unsupervised learning model. In this case, the machine learning model may learn patterns from the set of observations without labeling or supervision, and may provide output that indicates such patterns, such as by using clustering and/or association to identify related groups of items within the set of observations.

As shown by reference number 220, the machine learning system may train a machine learning model using the set of observations and using one or more machine learning algorithms, such as a regression algorithm, a decision tree algorithm, a neural network algorithm, a k-nearest neighbor algorithm, a support vector machine algorithm, and/or the like. After training, the machine learning system may store the machine learning model as a trained machine learning model 225 to be used to analyze new observations.

As shown by reference number 230, the machine learning system may apply the trained machine learning model 225 to a new observation, such as by receiving a new observation and inputting the new observation to the trained machine learning model 225. As shown, the new observation may include a first feature of location data X, a second feature of frequency and amplitude data Y, a third feature of terrestrial map location Z, and so on, as an example. The machine learning system may apply the trained machine learning model 225 to the new observation to generate an output (e.g., a result). The type of output may depend on the type of machine learning model and/or the type of machine learning task being performed. For example, the output may include a predicted value of a target variable, such as when supervised learning is employed. Additionally, or alternatively, the output may include information that identifies a cluster to which the new observation belongs, information that indicates a degree of similarity between the new observation and one or more other observations, and/or the like, such as when unsupervised learning is employed.

As an example, the trained machine learning model 225 may predict a value of predicted intensity or location A for the target variable of the predicted intensity or location for the new observation, as shown by reference number 235. Based on this prediction, the machine learning system may provide a first recommendation, may provide output for determination of a first recommendation, may perform a first automated action, may cause a first automated action to be performed (e.g., by instructing another device to perform the automated action), and/or the like.

In some implementations, the trained machine learning model 225 may classify (e.g., cluster) the new observation in a cluster, as shown by reference number 240. The observations within a cluster may have a threshold degree of similarity. As an example, if the machine learning system classifies the new observation in a first cluster (e.g., a location data cluster), then the machine learning system may provide a first recommendation. Additionally, or alternatively, the machine learning system may perform a first automated action and/or may cause a first automated action to be performed (e.g., by instructing another device to perform the automated action) based on classifying the new observation in the first cluster.

As another example, if the machine learning system were to classify the new observation in a second cluster (e.g., a frequency and amplitude data cluster), then the machine learning system may provide a second (e.g., different) recommendation and/or may perform or cause performance of a second (e.g., different) automated action.

In some implementations, the recommendation and/or the automated action associated with the new observation may be based on a target variable value having a particular label (e.g., classification, categorization, and/or the like), may be based on whether a target variable value satisfies one or more thresholds (e.g., whether the target variable value is greater than a threshold, is less than a threshold, is equal to a threshold, falls within a range of threshold values, and/or the like), may be based on a cluster in which the new observation is classified, and/or the like.

In this way, the machine learning system may apply a rigorous and automated process to predict terrestrial intensities or locations. The machine learning system enables recognition and/or identification of tens, hundreds, thousands, or millions of features and/or feature values for tens, hundreds, thousands, or millions of observations, thereby increasing accuracy and consistency and reducing delay associated with predicting terrestrial intensities or locations relative to requiring computing resources to be allocated for tens, hundreds, or thousands of operators to manually predict terrestrial intensities or locations.

As indicated above, FIG. 2 is provided as an example. Other examples may differ from what is described in connection with FIG. 2.

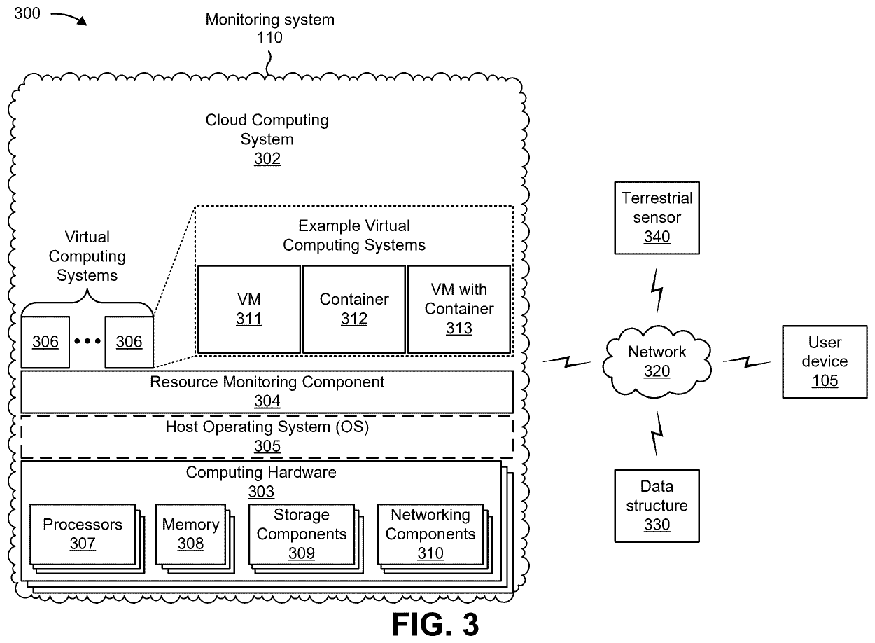

FIG. 3 is a diagram of an example environment 300 in which systems and/or methods described herein may be implemented. As shown in FIG. 3, the environment 300 may include the monitoring system 110, which may include one or more elements of and/or may execute within a cloud computing system 302. The cloud computing system 302 may include one or more elements 303-313, as described in more detail below. As further shown in FIG. 3, the environment 300 may include a user device 105, a network 320, a data structure 330, and/or an terrestrial sensor 340. Devices and/or elements of the environment 300 may interconnect via wired connections and/or wireless connections.

The user device 105 may include one or more devices capable of receiving, generating, storing, processing, and/or providing information, as described elsewhere herein. The user device 105 may include a communication device and/or a computing device. For example, the user device 105 may include a wireless communication device, a mobile phone, a smartphone, a noise meter, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. In some implementations, the user device 105 may include a GPS module for precise location tracking. The user device 105 may include a high-fidelity microphone capable of capturing terrestrial signals with a dynamic range of 120 decibels (dB) and a sampling rate of 48 kilohertz (kHz). The user device 105 may also include an accelerometer and a gyroscope to provide additional data for improving location accuracy. The user device 105 may transmit terrestrial and location data to the monitoring system 110 via a secure Wi-Fi or cellular connection, ensuring real-time data transmission.

The cloud computing system 302 includes computing hardware 303, a resource management component 304, a host operating system (OS) 305, and/or one or more virtual computing systems 306. The cloud computing system 302 may execute on, for example, an Amazon Web Services platform, a Microsoft Azure platform, or a Snowflake platform. The resource management component 304 may perform virtualization (e.g., abstraction) of the computing hardware 303 to create the one or more virtual computing systems 306. Using virtualization, the resource management component 304 enables a single computing device (e.g., a computer or a server) to operate like multiple computing devices, such as by creating multiple isolated virtual computing systems 306 from the computing hardware 303 of the single computing device. In this way, the computing hardware 303 can operate more efficiently, with lower power consumption, higher reliability, higher availability, higher utilization, greater flexibility, and lower cost than using separate computing devices.

The computing hardware 303 includes hardware and corresponding resources from one or more computing devices. For example, the computing hardware 303 may include hardware from a single computing device (e.g., a single server) or from multiple computing devices (e.g., multiple servers), such as multiple computing devices in one or more data centers. As shown, the computing hardware 303 may include one or more processors 307, one or more memories 308, one or more storage components 309, and/or one or more networking components 310. Examples of a processor, a memory, a storage component, and a networking component (e.g., a communication component) are described elsewhere herein.

The resource management component 304 includes a virtualization application (e.g., executing on hardware, such as the computing hardware 303) capable of virtualizing computing hardware 303 to start, stop, and/or manage one or more virtual computing systems 306. For example, the resource management component 304 may include a hypervisor (e.g., a bare-metal or Type 1 hypervisor, a hosted or Type 2 hypervisor, or another type of hypervisor) or a virtual machine monitor, such as when the virtual computing systems 306 are virtual machines 311. Additionally, or alternatively, the resource management component 304 may include a container manager, such as when the virtual computing systems 306 are containers 312. In some implementations, the resource management component 304 executes within and/or in coordination with a host operating system 305.

A virtual computing system 306 includes a virtual environment that enables cloud-based execution of operations and/or processes described herein using the computing hardware 303. As shown, the virtual computing system 306 may include a virtual machine 311, a container 312, or a hybrid environment 313 that includes a virtual machine and a container, among other examples. The virtual computing system 306 may execute one or more applications using a file system that includes binary files, software libraries, and/or other resources required to execute applications on a guest operating system (e.g., within the virtual computing system 306) or the host operating system 305.

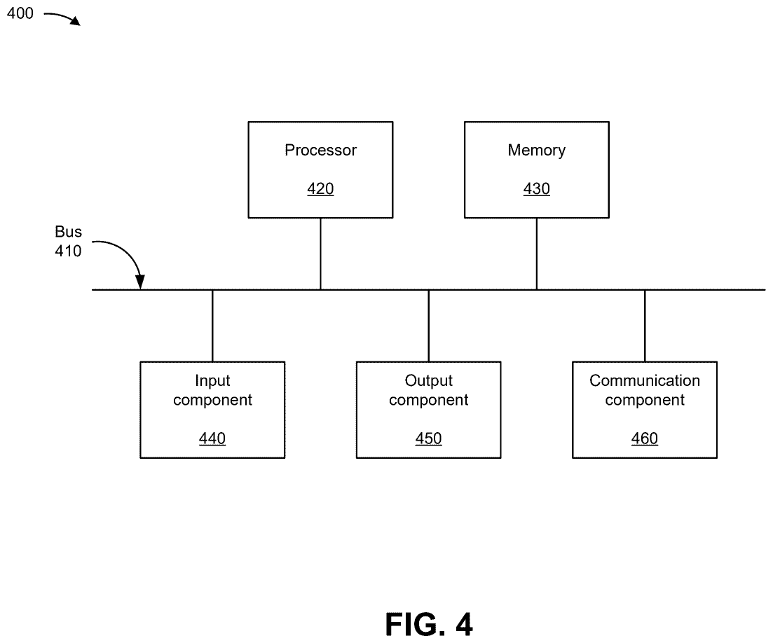

Although the monitoring system 110 may include one or more elements 303-313 of the cloud computing system 302, may execute within the cloud computing system 302, and/or may be hosted within the cloud computing system 302, in some implementations, the monitoring system 110 may not be cloud-based (e.g., may be implemented outside of a cloud computing system) or may be partially cloud-based. For example, the monitoring system 110 may include one or more devices that are not part of the cloud computing system 302, such as a device 400 of FIG. 4, which may include a standalone server or another type of computing device. The monitoring system 110 may perform one or more operations and/or processes described in more detail elsewhere herein.

The network 320 includes one or more wired and/or wireless networks. For example, the network 320 may include a cellular network, a public land mobile network (PLMN), a local area network (LAN), a wide area network (WAN), a private network, the Internet, and/or a combination of these or other types of networks. The network 320 enables communication among the devices of the environment 300.

The data structure 330 may include one or more devices capable of receiving, generating, storing, processing, and/or providing information, as described elsewhere herein. The data structure 330 may include a communication device and/or a computing device. For example, the data structure 330 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data structure 330 may communicate with one or more other devices of the environment 300, as described elsewhere herein.

The terrestrial sensor 340 may include one or more devices capable of receiving, generating, storing, processing, and/or providing information, as described elsewhere herein. In some implementations, the terrestrial sensor 340 may include a device that detects sound waves and converts the sound waves into an electrical signal. For example, the terrestrial sensor 340 may include a microphone, an ultrasonic sensor, a geophone, a piezoelectric sensor, a micro-electro-mechanical systems (MEMS) microphone, a laser microphone, a surface terrestrial wave (SAW) sensor, and/or the like. In some implementations, the terrestrial sensor 340 may include a MEMS microphone with a sensitivity of −38 decibels (dB) ±3 dB, a signal-to-noise ratio of 64 dB, and a frequency response range of 20 Hertz (Hz) to 20 kilohertz (kHz). The terrestrial sensor 340 may operate in temperatures ranging from −40° C. to 85° C. The terrestrial sensor 340 may be housed in a casing that withstands harsh environmental conditions within the infrastructure. In some implementations, the terrestrial sensor 340 may include a device that detects acoustic signals, magnetic signals, infrared signals, magnetic signals, wireless signals, and/or the like.

The number and arrangement of devices and networks shown in FIG. 3 are provided as an example. In practice, there may be additional devices and/or networks, fewer devices and/or networks, different devices and/or networks, or differently arranged devices and/or networks than those shown in FIG. 3. Furthermore, two or more devices shown in FIG. 3 may be implemented within a single device, or a single device shown in FIG. 3 may be implemented as multiple, distributed devices. Additionally, or alternatively, a set of devices (e.g., one or more devices) of the environment 300 may perform one or more functions described as being performed by another set of devices of the environment 300.

FIG. 4 is a diagram of example components of a device 400, which may correspond to the user device 105, the monitoring system 110, the data structure 330, and/or the terrestrial sensor 340. In some implementations, the user device 105, the monitoring system 110, the data structure 330, and/or the terrestrial sensor 340 may include one or more devices 400 and/or one or more components of the device 400. As shown in FIG. 4, the device 400 may include a bus 410, a processor 420, a memory 430, an input component 440, an output component 450, and a communication component 460.

The bus 410 includes one or more components that enable wired and/or wireless communication among the components of the device 400. The bus 410 may couple together two or more components of FIG. 4, such as via operative coupling, communicative coupling, electronic coupling, and/or electric coupling. The processor 420 includes a central processing unit, a graphics processing unit, a microprocessor, a controller, a microcontroller, a digital signal processor, a field-programmable gate array, an application-specific integrated circuit, and/or another type of processing component. The processor 420 is implemented in hardware, firmware, or a combination of hardware and software. In some implementations, the processor 420 includes one or more processors capable of being programmed to perform one or more operations or processes described elsewhere herein.

The memory 430 includes volatile and/or nonvolatile memory. For example, the memory 430 may include random access memory (RAM), read only memory (ROM), a hard disk drive, and/or another type of memory (e.g., a flash memory, a magnetic memory, and/or an optical memory). The memory 430 may include internal memory (e.g., RAM, ROM, or a hard disk drive) and/or removable memory (e.g., removable via a universal serial bus connection). The memory 430 may be a non-transitory computer-readable medium. The memory 430 stores information, instructions, and/or software (e.g., one or more software applications) related to the operation of the device 400. In some implementations, the memory 430 includes one or more memories that are coupled to one or more processors (e.g., the processor 420), such as via the bus 410.

The input component 440 enables the device 400 to receive input, such as user input and/or sensed input. For example, the input component 440 may include a touch screen, a keyboard, a keypad, a mouse, a button, a microphone, a switch, a sensor, a global positioning system sensor, an accelerometer, a gyroscope, and/or an actuator. The output component 450 enables the device 400 to provide output, such as via a display, a speaker, and/or a light-emitting diode. The communication component 460 enables the device 400 to communicate with other devices via a wired connection and/or a wireless connection. For example, the communication component 460 may include a receiver, a transmitter, a transceiver, a modem, a network interface card, and/or an antenna.

The device 400 may perform one or more operations or processes described herein. For example, a non-transitory computer-readable medium (e.g., the memory 430) may store a set of instructions (e.g., one or more instructions or code) for execution by the processor 420. The processor 420 may execute the set of instructions to perform one or more operations or processes described herein. In some implementations, execution of the set of instructions, by one or more processors 420, causes the one or more processors 420 and/or the device 400 to perform one or more operations or processes described herein. In some implementations, hardwired circuitry may be used instead of or in combination with the instructions to perform one or more operations or processes described herein. Additionally, or alternatively, the processor 420 may be configured to perform one or more operations or processes described herein. Thus, implementations described herein are not limited to any specific combination of hardware circuitry and software.

The number and arrangement of components shown in FIG. 4 are provided as an example. The device 400 may include additional components, fewer components, different components, or differently arranged components than those shown in FIG. 4. Additionally, or alternatively, a set of components (e.g., one or more components) of the device 400 may perform one or more functions described as being performed by another set of components of the device 400.

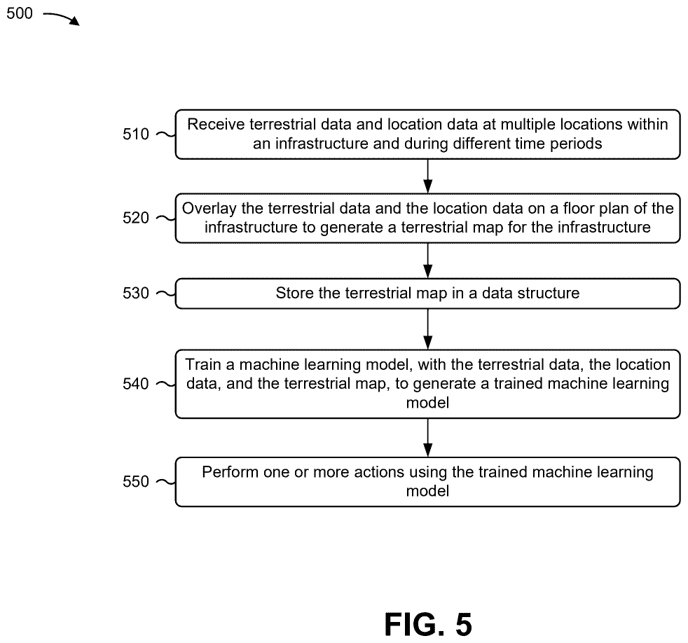

FIG. 5 depicts a flowchart of an example process 500 for navigating and monitoring infrastructure using terrestrial signals. In some implementations, one or more process blocks of FIG. 5 may be performed by a device (e.g., the monitoring system 110). In some implementations, one or more process blocks of FIG. 5 may be performed by another device or a group of devices separate from or including the device, such as a user device (e.g., the user device 105). Additionally, or alternatively, one or more process blocks of FIG. 5 may be performed by one or more components of the device 400, such as the processor 420, the memory 430, the input component 440, the output component 450, and/or the communication component 460.

As shown in FIG. 5, process 500 may include receiving terrestrial data and location data at multiple locations within an infrastructure and during different time periods (block 510). For example, the device may receive terrestrial data and location data at multiple locations within an infrastructure and during different time periods, as described above. In some implementations, receiving the terrestrial data and the location data includes receiving the terrestrial data and the location data from a user device at the multiple locations of the infrastructure during the different time periods. In some implementations, the infrastructure includes one or more of a data center, a server room, a warehouse, or a factory.

As further shown in FIG. 5, process 500 may include overlaying the terrestrial data and the location data on a floor plan of the infrastructure to generate an terrestrial map for the infrastructure (block 520). For example, the device may overlay the terrestrial data and the location data on a floor plan of the infrastructure to generate an terrestrial map for the infrastructure, as described above.

As further shown in FIG. 5, process 500 may include storing the terrestrial map in a data structure associated with the device (block 530). For example, the device may store the terrestrial map in a data structure associated with the device, as described above.

As further shown in FIG. 5, process 500 may include training a machine learning model, with the terrestrial data, the location data, and the terrestrial map, to generate a trained machine learning model (block 540). For example, the device may train a machine learning model, with the terrestrial data, the location data, and the terrestrial map, to generate a trained machine learning model, as described above. In some implementations, training the machine learning model includes training an LSTM model, with the terrestrial data, the location data, and the terrestrial map, to predict terrestrial intensities at various locations within the infrastructure at various times. In some implementations, training the machine learning model includes training a CNN model, with the terrestrial data, the location data, and the terrestrial map, to predict various locations within the infrastructure at various times.

As further shown in FIG. 5, process 500 may include performing one or more actions using the trained machine learning model (block 550). For example, the device may perform one or more actions using the trained machine learning model, as described above. In some implementations, performing the one or more actions includes monitoring the infrastructure in real-time using the trained machine learning model to identify one or more deviations from one or more expected terrestrial patterns, and generating an alert based on the one or more deviations from the one or more expected terrestrial patterns.

In some implementations, performing the one or more actions includes receiving an terrestrial intensity from an terrestrial sensor at a location within the infrastructure and at a time, utilizing the trained machine learning model to generate a predicted terrestrial intensity at the location and the time, determining that the terrestrial intensity sufficiently deviates from the predicted terrestrial intensity, and generating an alert based on determining that the terrestrial intensity sufficiently deviates from the predicted terrestrial intensity. In some implementations, generating the alert includes sending, to a remote system, a notification indicating that the terrestrial intensity sufficiently deviates from the predicted terrestrial intensity.

In some implementations, performing the one or more actions includes receiving, from a user device, a request for a location of the user device in the infrastructure based on an terrestrial intensity captured by the user device, utilizing the trained machine learning model to predict the location of the user device based on the terrestrial intensity, and providing the location to the user device. In some implementations, the location causes the user device to provide the location and a wireless signal to another user device for determining a location of the other user device within the infrastructure. In some implementations, the location causes the user device to broadcast a nearness terrestrial signal to enable other user devices to determine locations within the infrastructure.

In some implementations, process 500 includes utilizing a Fourier transform to generate frequency and amplitude data based on the terrestrial data. In some implementations, process 500 includes providing the terrestrial map to a mobile edge computing device.

Although FIG. 5 shows example blocks of process 500, in some implementations, process 500 may include additional blocks, fewer blocks, different blocks, or differently arranged blocks than those depicted in FIG. 5. Additionally, or alternatively, two or more of the blocks of process 500 may be performed in parallel.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the implementations. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

As used herein, “selectively” performing an operation means to either perform the operation or refrain from performing the operation. For example, selectively performing an operation based on whether a condition is satisfied means that the operation is performed if the condition is satisfied and that the operation is not performed if the condition is not satisfied (or vice versa). Thus, selectively performing an operation may include determining whether to perform the operation and then either performing the operation or refraining from performing the operation based on that determination.

As used herein, “selectively” performing a first operation or a second operation means to perform either the first operation or the second operation. For example, selectively performing a first operation or a second operation based on whether a condition is satisfied means that the first operation is performed if the condition is satisfied and that the second operation is performed if the condition is not satisfied (or vice versa). Thus, selectively performing a first operation or a second operation may include determining whether to perform either the first operation or the second operation and then performing either the first operation or the second operation based on that determination.

To the extent the aforementioned implementations collect, store, or employ personal information of individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense.

What is claimed is:

1. A method, comprising:
receiving, by a device, terrestrial data and location data at multiple locations within an infrastructure and during different time periods;
overlaying, by the device, the terrestrial data and the location data on a floor plan of the infrastructure to generate an terrestrial map for the infrastructure;
storing, by the device, the terrestrial map in a data structure associated with the device;
training, by the device, a machine learning model, with the terrestrial data, the location data, and the terrestrial map, to generate a trained machine learning model; and
performing, by the device, one or more actions using the trained machine learning model.

2. The method of claim 1, wherein performing the one or more actions comprises:
monitoring the infrastructure in real-time using the trained machine learning model to identify one or more deviations from one or more expected terrestrial patterns; and
generating an alert based on the one or more deviations from the one or more expected terrestrial patterns.

3. The method of claim 1, wherein receiving the terrestrial data and the location data comprises:
receiving the terrestrial data and the location data from a user device at the multiple locations of the infrastructure during the different time periods.

4. The method of claim 1, further comprising:
utilizing a Fourier transform to generate frequency and amplitude data based on the terrestrial data.

5. The method of claim 1, wherein training the machine learning model comprises:
training a long short-term memory (LSTM) model, with the terrestrial data, the location data, and the terrestrial map, to predict terrestrial intensities at various locations within the infrastructure at various times.

6. The method of claim 1, wherein training the machine learning model comprises:
training a convolutional neural network (CNN) model, with the terrestrial data, the location data, and the terrestrial map, to predict various locations within the infrastructure at various times.

7. The method of claim 1, further comprising:
providing the terrestrial map to a mobile edge computing device.

8. A device, comprising:
one or more processors configured to:
receive terrestrial data and location data at multiple locations within an infrastructure and during different time periods;
overlay the terrestrial data and the location data on a floor plan of the infrastructure to generate an terrestrial map for the infrastructure;
store the terrestrial map in a data structure associated with the device;
provide the terrestrial map to a mobile edge computing device;
train a machine learning model, with the terrestrial data, the location data, and the terrestrial map, to generate a trained machine learning model; and
perform one or more actions using the trained machine learning model.

9. The device of claim 8, wherein the one or more processors, to perform the one or more actions, are configured to:
receive an terrestrial intensity from an terrestrial sensor at a location within the infrastructure and at a time;
utilize the trained machine learning model to generate a predicted terrestrial intensity at the location and the time;
determine that the terrestrial intensity sufficiently deviates from the predicted terrestrial intensity; and
generate an alert based on determining that the terrestrial intensity sufficiently deviates from the predicted terrestrial intensity.

10. The device of claim 9, wherein the one or more processors, to generate the alert, are configured to:
send, to a remote system, a notification indicating that the terrestrial intensity sufficiently deviates from the predicted terrestrial intensity.

11. The device of claim 8, wherein the one or more processors, to perform the one or more actions, are configured to:
receive, from a user device, a request for a location of the user device in the infrastructure based on an terrestrial intensity captured by the user device;
utilize the trained machine learning model to predict the location of the user device based on the terrestrial intensity; and
provide the location to the user device.

12. The device of claim 11, wherein the location causes the user device to provide the location and a wireless signal to another user device for determining a location of the other user device within the infrastructure.

13. The device of claim 11, wherein the location causes the user device to broadcast a nearness terrestrial signal to enable other user devices to determine locations within the infrastructure.

14. The device of claim 8, wherein the infrastructure includes one or more of a data center, a server room, a warehouse, or a factory.

15. A non-transitory computer-readable medium storing a set of instructions, the set of instructions comprising:
one or more instructions that, when executed by one or more processors of a device, cause the device to:
receive terrestrial data and location data at multiple locations within an infrastructure and during different time periods,
wherein the terrestrial data and the location data is received from a user device at the multiple locations of the infrastructure during the different time periods;
overlay the terrestrial data and the location data on a floor plan of the infrastructure to generate an terrestrial map for the infrastructure;
store the terrestrial map in a data structure associated with the device;
train a machine learning model, with the terrestrial data, the location data, and the terrestrial map, to generate a trained machine learning model; and
perform one or more actions using the trained machine learning model.

16. The non-transitory computer-readable medium of claim 15, wherein the one or more instructions, that cause the device to perform the one or more actions, cause the device to:
monitor the infrastructure in real-time using the trained machine learning model to identify one or more deviations from one or more expected terrestrial patterns; and
generate an alert based on the one or more deviations from the one or more expected terrestrial patterns.

17. The non-transitory computer-readable medium of claim 15, wherein the one or more instructions further cause the device to:
utilize a Fourier transform to generate frequency and amplitude data based on the terrestrial data.

18. The non-transitory computer-readable medium of claim 15, wherein the one or more instructions, that cause the device to train the machine learning model, cause the device to:
train a long short-term memory (LSTM) model, with the terrestrial data, the location data, and the terrestrial map, to predict terrestrial intensities at various locations within the infrastructure at various times.

19. The non-transitory computer-readable medium of claim 15, wherein the one or more instructions, that cause the device to train the machine learning model, cause the device to:
train a convolutional neural network (CNN) model, with the terrestrial data, the location data, and the terrestrial map, to predict various locations within the infrastructure at various times.

20. The non-transitory computer-readable medium of claim 15, wherein the one or more instructions, that cause the device to perform the one or more actions, cause the device to:
receive an terrestrial intensity from an terrestrial sensor at a location within the infrastructure and at a time;
utilize the trained machine learning model to generate a predicted terrestrial intensity at the location and the time;
determine that the terrestrial intensity sufficiently deviates from the predicted terrestrial intensity; and
generate an alert based on determining that the terrestrial intensity sufficiently deviates from the predicted terrestrial intensity.
